(19) United States
(12) Patent Application Publication
(10) Pub. No.: US 2004/0243525 A1
(43) Pub. Date: Dec. 2, 2004

(54) System and method for disconnecting utility services

(76) Inventor: Brian Forrester, Greer, SC (US)

Correspondence Address: McNair Law Firm, P.A., P.O. Box 10827, Greenville, SC, 29603-0827, US

(21) Appl. No.: 10/884,076

(22) Filed: Jul. 2, 2004

Related U.S. Application Data
(63) Continuation-in-part of application No. 10/827,188, filed on Apr. 19, 2004.
(60) Provisional application No. 60/468,594, filed on May 7, 2003.

(51) Int. Cl. G06F 17/60

(52) U.S. Cl. 705/412; 705/1

(57) ABSTRACT

A system for assisting in administration of utility service. The system contains two computer readable media. A set of customer information is embodied in the first computer readable medium having account information for customers. A first set of computer readable instructions is for retrieving account information for at least one customer that is delinquent in payment, determining whether the utility service of the customer should be disconnected, creating disconnection information containing customer location information, sending disconnection information to the second computer readable medium representing the customer's service is to be disconnected. The system may also include a second set of computer readable instructions for receiving disconnection information from the first computer readable medium to provide the location of at least one customer to have utility services disconnected, and receiving status information representing the status of the disconnection process, and transmitting the status information to the first computer readable medium.

### CROSS REFERENCE TO RELATED APPLICATION

This application is a continuation-in-part of application Ser. No. 10/827,188, filed Apr. 19, 2004 which claims priority of provisional application Ser. No. 60/468,594, filed May 7, 2003.

### FIELD OF THE INVENTION

This invention is directed to a system and method for assisting in the administrative tasks associated with the disconnection of services, specifically for customers who are delinquent in their payment.

### BACKGROUND OF THE INVENTION

Traditionally, customers who do not pay utility companies the amount owed for the utilities provided to the customer have their service disconnected by the utility. Usually this process involves several steps and warnings to the customer indicating that if payment is not remitted to the company, then services will be disconnected. The customer is given until a certain date to pay their outstanding bill prior to their service being disconnected. The date the service is to be disconnected, an employee of the utility travels to the residence of a customer who has not remitted payment to the company in a timely manner. Upon arriving at the house, the employee of the utility must call the utility office to determine if payment has been remitted on that day. If payment has not been remitted that date then the employee of the utility disconnects the power, water, gas, or other utility provided by the company.

Multiple systems have been developed that attempt to automate the cut-off of power for a customer who has not paid their bills. For example, U.S. Pat. No. 6,373,399 discloses the use of an automated system for cutting off power automatically from a remote location. This system falls short in that it necessitates the use of a remote location, and a specialized meter that can be remotely accessed so as to cease allowing power to enter the home. While this system could effectively achieve the results of accurately determining if payment has been made prior to cutting off power as the system is complete integrated, it falls short in that it requires a special onsite meter, and is specifically oriented to power only. Also note, the special meter required would be too expensive. It would be more advantageous to have a system that allows for the cut-off of a variety of services provided by utility without the need for a separate specialized onsite meter.

The traditional use of a technician arriving at a house to disconnect service and calling the utility billing office to determine if payment has been made clearly falls short of providing an effective system for cutting off power and maintaining administrative tasks associated with that cut-off. The automated systems described above require a prohibitive cost to update and create meters that control the cut-off of service from a remote location. Further, these systems are only disclosed as for use in the electric utility area, and not for water, gas, and other forms of services provided by utilities.

Accordingly, it is an object of the invention to provide for an automated system for the disconnecting of services for delinquent customers.

It is another object of this invention to provide for an automated system and method for assisting in the administrative tasks associated with the disconnection of service to customers delinquent in their payments.

### SUMMARY OF THE INVENTION

The above objectives are accomplished by providing a system for assisting in administration of utility service. They system contains a first computer readable medium and a second computer readable medium in communication with the first computer readable medium. A set of customer information is embodied in the first computer readable medium having account information for customers. A first set of computer readable instructions is in communication with said first computer readable medium. The instruction are for retrieving account information for at least one customer that is delinquent in payment, determining whether the utility service of the customer should be disconnected, creating disconnection information containing customer location information, sending disconnection information from the first computer readable medium to the second computer readable medium representing the customer's service is to be disconnected.

The system may also include a second set of computer readable instructions in communication with the second computer readable medium for receiving disconnection information from the first computer readable medium so that the location of said at least one customer to have utility services disconnected is provided. The second set of computer readable instructions may also include instructions for receiving status information representing the status of the disconnection process, and transmitting the status information to the first computer readable medium. The second set of computer readable instructions may also include instructions for transmitting the status information to the first computer readable medium.

The system may also include a manager computer readable medium in communication with the first and second computer readable media. A set of computer readable manager instructions are in communication with the manager computer readable medium. The set of computer readable manager instructions include instructions for approving the customers who are delinquent in payment for disconnection of service prior to transmitting the information to the second computer readable medium. The system of may also include a set of web service computer readable instructions in communication with said first computer readable medium for providing access to said billing system over a wide area network. The first computer readable medium can communicate with the second computer readable medium through a wireless medium.

### DESCRIPTION OF THE DRAWINGS

FIG. 1 is a schematic illustrating components used with this invention.

FIG. 2 is a flowchart of the invention from the billing system's point of view.

FIG. 3 is a flowchart of the invention from the portable device's point of view.

### DETAILED DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

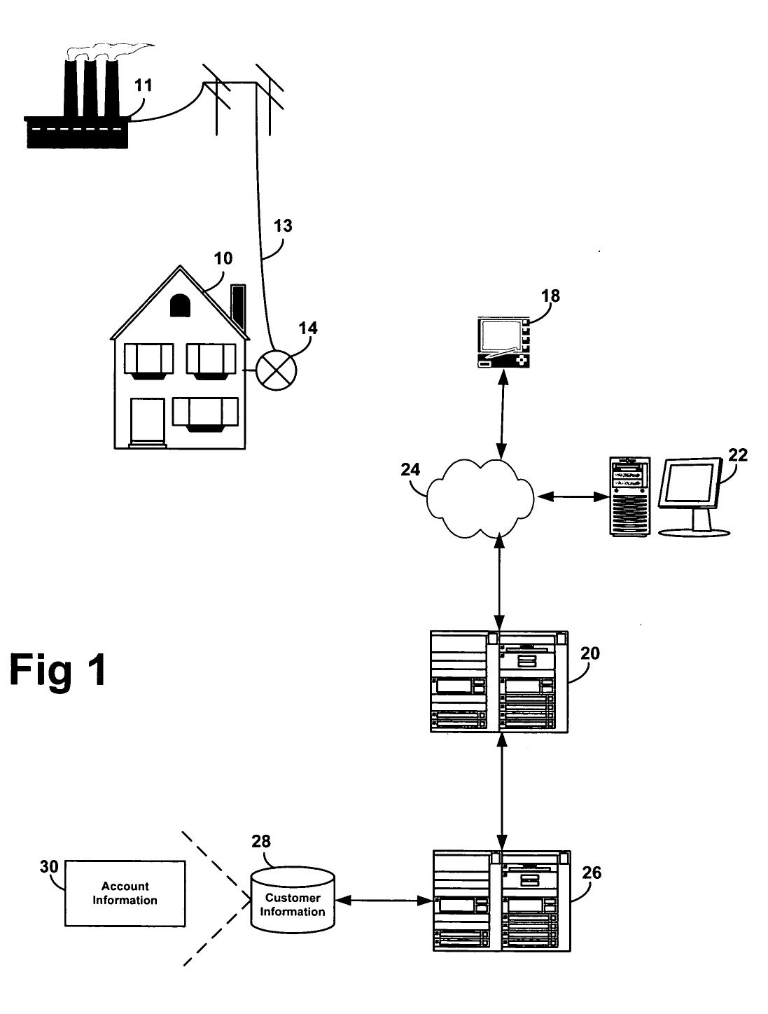

Referring now to FIG. 1, the consumer of utility services 10 receives services from utility 11. The services are delivered through delivery means 13 that are then measured through traditional meter 14. Utility services can include the providing of gas, water, and electricity amongst other types of utility services. Certain utilities provide a variety of utility services while others provide only one. In FIG. 1, the utility service being depicted is a service for providing electricity. This is done for example purposes only, and does not preclude this invention for all other utility services, including but not limited, to those listed above. At another location, the utilities' administrative offices contain several computers including billing system 26. Note that these computers can be contained in administrative offices that are on the same site as the plant 11 shown or can be at another location. A commonly used traditional billing system is one that is designed to run on the AS/400 system manufactured by IBM.

Billing system 26 contains a variety of information about the customers of the utility. The information about the customers can be in a preferred embodiment stored in a data base and preferably, a relational data base. The data base allows for easy retrieval of information for a variety of customers and for a variety of information about each customer. The billing system may communicate through a variety of means with web service 20. The billing system and web service may be located on the same computer or on a variety of computers communicating via a network connection including but not limited to Ethernet connections, wireless communications, etc. In the preferred embodiment, the web service is shown existing on a separate computer and in communication with billing system 26.

This information includes customer information 28 and account information 30. Account information is information concerning the utility service customer. Account information can include the payment history, account balance history, current payment last payment, service usage history, current charges, payment due date, interest for delinquent payments, customer location and other customer information. While account information can also include a delinquency status, the delinquency of the customer can also be determined from the current charges, last payment, payment due date, or other similar information.

Billing system 26 is in communication with web service 20. Web service 20 provides the ability for billing system to transmit data over a network 24. Note that network 24 may be the Internet, another wide area network or a local area network.

Also note that web service 20 is not necessary in all billing systems. Some billing systems are capable of transmitting information over a network while others are not. In a preferred embodiment the existing billing system of a utility can be used with the additional functionality provided by the delinquent disconnection system and method. Disconnection manager 22 has access to the payment information and location information on billing system 26 via wide area network 24 and web service 20. As will be explained below, the disconnection manager needs access to the information so as to approve any disconnections that are to be made. Portable computer 18, which is deployed in the field, is also in communication with billing system 26 via network 24 and web service 20. Note that a variety of devices can be used for the portable computer, including but not limited to, laptops, desktops, PDAs and servers. As will be described in more detail below the technician selected to perform a disconnection of service at home 10 will use portable computer 18 to communicate with billing system 26 to insure the need for the disconnection, and assist in maintaining accurate records relating to the disconnection of services. Note that in one embodiment, portable computer 18 is in communication with the other computers via a wireless connection.

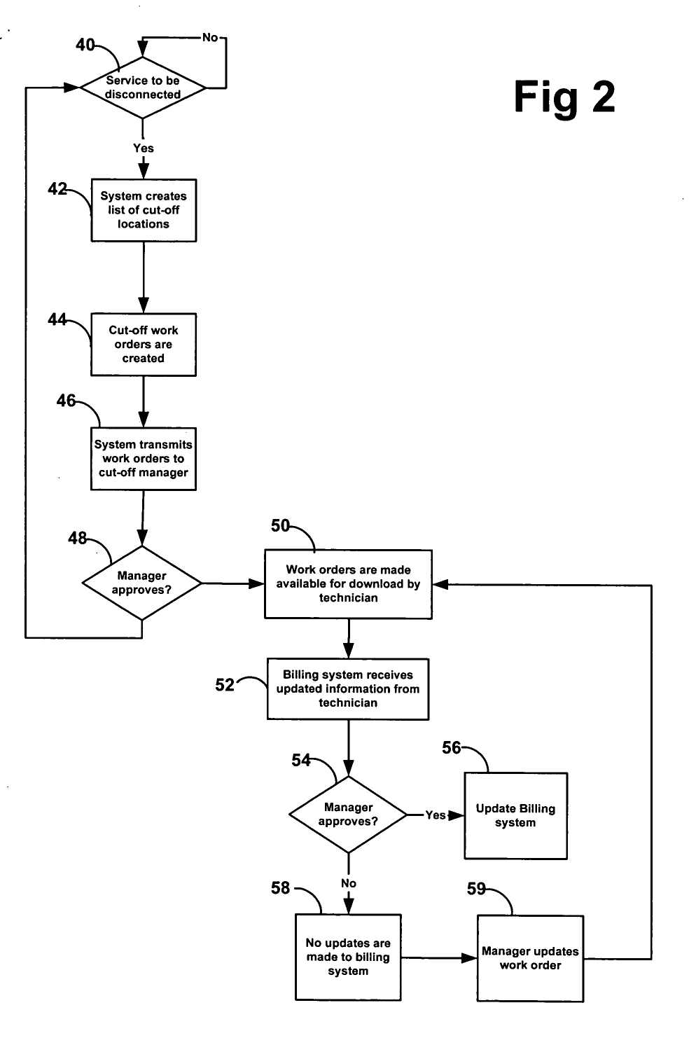

FIG. 2 is a flowchart detailing the operation of the system of disconnecting services for delinquent customers from the billing system's point of view. If there is a customer whose service should be disconnected at step 40, the billing system will create a list of disconnections at step 42 based on the determination at step 40 of whose service needs to be discontinued. Note that the list of disconnections created at step 42 can include one home or a plurality of homes and businesses, including any consumers of the services provided by the utility whose payment is delinquent. The set of computer readable instructions can make a determination as to whether the customer's service should be disconnected based upon the customer's delinquency status. For example, the customer's service could be scheduled for disconnection immediately upon a delinquency determination or thereafter some predetermined period of time.

Once the list of potential disconnections is created at step 42, the system creates work orders for each of the disconnections to take place at step 44. A work order is a collection of information including the location of the work to be performed, and a description of the work to be performed. Note that additional information can, but does not always have to be included, in this work order. Once those work orders are created, the billing system transmits them to the disconnection manager at step 46. The disconnection manager then either approves or withholds approval for the disconnections to take place at step 48. It is important to have a disconnection manager in a preferred embodiment so that, for example, a hospital that needs constant services from a utility does not accidentally have their services disconnected inadvertently. Therefore, having the disconnection manager assist in a decision at step 48 is highly advantageous in maintaining an accurate, safe and efficient system. Note that the disconnection manager may be an individual using the computer that receives the information making individual decisions, or alternatively could be a set of computer readable instructions that include data for situations where utility services should not be disconnected under any circumstances. Further note that in alternative embodiments, the creation of work orders for disconnections can be done without the use of a disconnection manager.

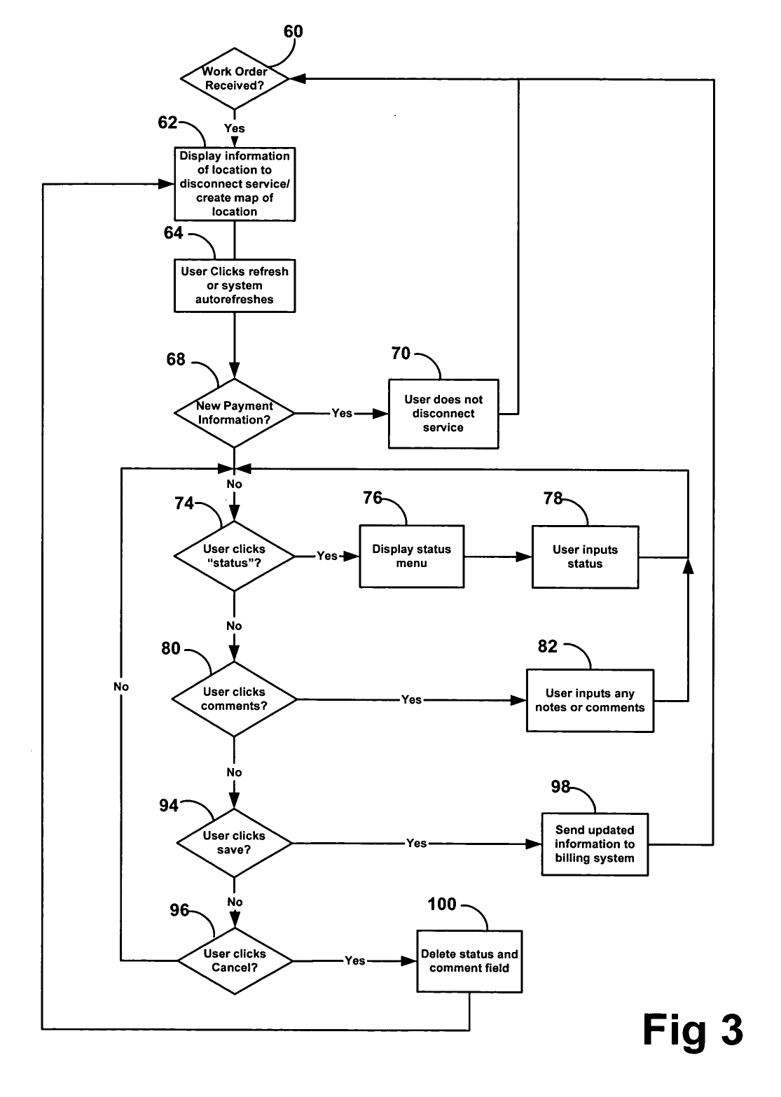

Once those work orders have been approved, they are made available for download by technicians at step 50. The technician then receives the work order, performs a disconnection activity (including but not limited to disconnecting the service, re-disconnecting the service, and observing the service area to determine status of service), and performs updates on the portable device as described in FIG. 3. Once the disconnection has been performed, the billing system receives that information from the portable computer at step 52. The information includes whether or not service was disconnected, if service was not disconnected, why it was not disconnected, status of the disconnection, etc.

The actions taken by the technician can be subject to manager approval. At step 54, the manager approves the information that has been transmitted from the portable computer and the billing system is updated at step 56. Should the manager not approve the information received at step 54, then step 58 shows that no updates are made to the information on the system. The manager then updates the work order at step 59 and the system returns to step 50.

Referring now to FIG. 3 the process of disconnecting power due to delinquent payment and performing the administrative tasks associated with that disconnection is shown through a flowchart from the point of view of the portable device. The portable computer begins operation by determining if a new work order has been received at step 60. If one has been received, the portable computer displays the location that should have its service disconnected associated with the work order at step 62. At this point, the technician would travel to the location indicated in the location information in the work order and prepare to disconnect the services at the home. Once the technician is ready to disconnect service, the technician will click the refresh button at step 64. Note that the refresh button can be a touch screen command, a command entered by pressing a key or button of the portable device, or any other means of transmitting a command indicating that the information on the portable device should be refreshed. Note that in alternative embodiments, the portable computer may be pre-programmed to automatically refresh after a pre-determined period of time. The refresh button automatically communicates with the billing system to determine if any new payment information is available at step 68. The billing system is updated automatically by whoever receives payment for the services. This includes any payment that is made automatically over the Internet, any payment made to a teller onsite, and any payment that is received via mail. Once that payment has been received, the billing system is updated indicating payment has been made. As this payment can occur after the work order has been created for the disconnection of power, but before the disconnection has taken place, it is advantageous for the technician to be able to access this information before disconnecting service. If there is new payment information at step 68 that indicates payment has been made and no disconnection is needed, at step 70 the technician will not cut off the services to that customer. The system will then return to step 60 to await a new work order. If no new payment information is available at step 68, then the system advances to step 74. If the technician clicks the status drop down menu at step 74, the status menu is displayed at step 76. The technician then inputs one of the status codes at step 78. The status codes in a preferred embodiment can include, but are not limited to, paid, held, disconnect, still cut, re-cut, left note, and other. The technician will select one of these to indicate the services he has provided or the observations he has made. Once the technician has input the status, the system will return to step 74. Should the technician not click the status drop down menu, then the technician may click the comments field at step 80. If the user does so, then the technician may input their comments at step 82. Note that in a preferred embodiment the technician comment box is a text box that allows a technician to input any text associated with their disconnection work order. Once the technician has input their comments, the system returns to step 74. Once the technician has finished inputting status and/or comments and chooses not to enter anything else in these fields, the technician may click the save changes button at step 94. If the technician does so, the system advances to step 98 where updated information is sent to the billing system. The technician does not click save at step 94. They may click cancel at step 96. If the technician does not click cancel then the system returns to step 74. If the technician does click cancel, the system advances to step 100 where all the status and comments are that have been made are removed and no new information is included on the work order. Note that if no connection is available to the host computer, the status information is saved on the portable computer and transmitted either individually or via batch process once a connection is available. Once the updated information has been sent to the billing system at step 98, then the billing system will perform as described above in FIG. 2. Note that additional functionality can be available for the portable computer, including but not limited to, a mapping function for mapping the location of the portable computer and a tracking function for tracking the location of the portable computer via GPS or other satellite technology.

While a preferred embodiment of the invention has been described using specific terms, such description is for illustrative purposes only, and it is to be understood that changes and variations may be made without departing from the spirit or scope of the following claims.

What is claimed is:

1. A system for assisting in administration of utility services comprising:
a first computer readable medium;
a second computer readable medium in communication with said first computer readable medium;
a set of customer information embodied in said first computer readable medium having account information representing customers' information;
a first set of computer readable instructions in communication with said first computer readable medium for retrieving said account information for at least one customer that is delinquent in payment, determining whether the utility service of said customer should be disconnected, creating disconnection information containing customer location information, sending disconnection information from said first computer readable medium to said second computer readable medium representing that the customer's service is to be disconnected;
a second set of computer readable instructions in communication with said second computer readable medium for receiving said disconnection information from said first computer readable medium so that the location of said at least one customer to have utility services disconnected is provided.

2. The system of claim 1 wherein said second set of computer readable instructions includes instructions for receiving status information representing the status of the disconnection process.

3. The system of claim 2 wherein said second set of computer readable instructions includes instructions for transmitting said status information to said first computer readable medium.

4. The system of claim 1 wherein said first set of computer readable instructions includes instructions for updating said account information with status information from said second computer readable medium, to reflect updated disconnection status.

5. The system of claim 1 wherein said first set of computer readable instructions include instructions for creating a work order representing disconnection information for a customer who is delinquent in payment.

6. The system of claim 1 further comprising:
a manager computer readable medium in communication with said first computer readable medium and said second computer readable medium; and,
a set of computer readable manager instructions in communication with said manager computer readable medium for approving customers who are delinquent in payment for disconnection of service prior to sending said disconnection information to said second computer readable medium.

7. The system of claim 1 further comprising a third set of computer readable instructions in communication with said first computer readable medium for receiving disconnection information, formatting said disconnection information for access over the world wide web, and transmitting disconnection information over a network.

8. The system of claim 7 wherein said third set of computer readable instructions include instructions for receiving and transmitting status information.

9. The system of claim 1 wherein said second set of computer readable instructions include instructions for requesting updated disconnection information from said first computer readable medium, receiving said updated disconnection information, and providing said updated disconnection information to a user of said second computer readable medium.

10. The system of claim 1 wherein said first computer readable medium communicates with said second computer readable medium through a wireless medium.

11. The system of claim 1 further comprising a portable housing, wherein said second computer readable medium is embodied in said portable housing.

12. The system of claim 1 further comprising a display device in communication with said second computer readable medium for displaying disconnection information to a user of said second computer readable medium.

13. A system for assisting in the administration of utility services comprising:
a computer readable medium;
a set of computer readable instructions in communication with said computer readable medium for receiving disconnection information representing the delinquency of at least one customer having customer location information, providing said disconnection information to a user so that the user is informed of the customer and location to perform a disconnection activity, receiving status information entered from the user representing the status of the disconnection activity, and transmitting said status information representing the status of the disconnection activity.

14. The system of claim 13 wherein said set of computer readable instructions include instructions for requesting updated disconnection information, receiving said updated disconnection information representing the current delinquency status of at least one customer, and providing said updated disconnection information to the user.

15. The system of claim 13 wherein said computer readable instructions include instructions for communicating through a wireless medium.

16. The system of claim 13 wherein said set of computer readable instructions include instructions for creating a map representing the location for at least one customer for which a disconnection activity is to be performed.

17. The system of claim 13, wherein said set of computer readable instructions include instructions for tracking the physical location of said computer readable medium.

18. A system for assisting in administration of utility services comprising:
a computer readable medium;
a set of customer information embodied in said computer readable medium having account information for customers;
a set of computer readable instructions in communication with said computer readable medium for retrieving said account information for at least one customer that is delinquent in payment, determining whether the utility service of said customer should be disconnected, creating disconnection information containing customer location information, sending disconnection information from said computer readable medium to a second computer readable medium representing that the customer's service is to be disconnected.

19. The system of claim 18 wherein said set of computer readable instructions includes instructions for updating said account information with status information received from the second computer readable medium to reflect updated disconnection status.

20. The system of claim 18 wherein said set of computer readable instructions include instructions for creating a work order representing disconnection information for a customer who is delinquent in payment.

21. The system of claim 18 further comprising:
a manager computer readable medium in communication with said first computer readable medium and said second computer readable medium; and,
a set of computer readable manager instructions in communication with said manager computer readable medium for approving customers who are delinquent in payment for disconnection of service prior to sending said disconnection information to said second computer readable medium.

22. The system of claim 18 further comprising a third set of computer readable instructions in communication with said first computer readable medium for receiving disconnection information, formatting said disconnection information for access over the world wide web, and transmitting disconnection information over a network.

23. The system of claim 22 wherein said third set of computer readable instructions include instructions for receiving and transmitting status information.

24. The system of claim 18 wherein said set of first computer readable instructions include instructions for creating a list of customers who are delinquent in payment.
